(19) United States
(12) Patent Application Publication
(10) Pub. No.: US 2026/0204953 A1
(43) Pub. Date: Jul. 16, 2026

(54) RADIO FREQUENCY RECTIFIER DEVICE

(71) Applicant: REALTEK SEMICONDUCTOR CORP., Hsinchu (TW)

(72) Inventor: Rong-Fu Yeh, Hsinchu (TW)

(73) Assignee: REALTEK SEMICONDUCTOR CORP., Hsinchu (TW)

(21) Appl. No.: 19/368,361

(22) Filed: Oct. 24, 2025

(30) Foreign Application Priority Data
Jan. 10, 2025 (TW) 114101215

(51) Int. Cl. H02J 50/27; H02J 50/00; H02M 1/00; H02M 7/217

(52) U.S. Cl. CPC H02J 50/27; H02J 50/001; H02M 1/0048; H02M 7/217

(57) ABSTRACT

The disclosure provides a radio frequency rectifier device, including a first input node, a first capacitor, a second input node, a second capacitor, a first transistor element, a second transistor element, a third capacitor, a fourth capacitor, a third transistor element, a fourth transistor element, a fifth capacitor, a sixth capacitor, a first conductive element, a second conductive element, a third conductive element, a fourth conductive element, a load resistor and a load capacitor. When the first conduction element, the second conduction element, the third conduction element and the fourth conduction element are turned on, a gate voltage of the first transistor element, a gate voltage of the second transistor element, a gate voltage of the third transistor element and a gate voltage of the fourth transistor element are reduced respectively. These operations reduce a leakage current and a discharge interval of the transistor element, thereby improving power conversion efficiency.

### CROSS-REFERENCE TO RELATED APPLICATION

This non-provisional application claims priority under 35 U.S.C. § 119(a) to Patent Application No. 114101215 filed in Taiwan, R.O.C. on January 10, 2025, the entire contents of which are hereby incorporated by reference.

### BACKGROUND

### Technical Field

The disclosure relates to a radio frequency rectifier device, and in particular, to a radio frequency rectifier device with a self-bias.

### Related Art

In a radio frequency energy capturing system, a rectifier circuit is a key core element, where the efficiency of the rectifier circuit refers to the energy conversion efficiency of converting radio frequency signals into a direct current (DC). This efficiency is usually determined according to many factors, such as impedance conversion rate of matching network, diode performance, circuit architecture, input signal strength and load impedance. Where ideal, the conversion efficiency of the rectifier circuit may reach 90% or above, but in practical application, affected by various non-ideal factors, the conversion efficiency of the rectifier circuit may be limited.

In the design of the radio frequency energy capturing system, the rectifier circuit usually faces several challenges: the radio frequency signal input strength and the like. In current application scenarios, the radio frequency energy capturing system needs to work at low power of a micro-watt or nano-watt level, which may greatly affect the rectifier circuit and reduce energy capturing performance. Moreover, due to the reverse leakage effect of the rectifier circuit, when a DC voltage of an energy storage element is higher than an input voltage of the rectifier circuit, which may cause a discharge effect of the energy storage element, thereby resulting in lower radio frequency power conversion efficiency. Furthermore, to improve the sensitivity of the rectifier circuit, a zero threshold voltage (ZVT) process element may be used. However, while the ZVT element can improve the receiving sensitivity, it also increases the reverse leakage current of the rectifier circuit and reduces the power conversion efficiency.

### SUMMARY

The disclosure provides a radio frequency rectifier device, which includes a first input node, a first capacitor, a second input node, a second capacitor, a first transistor element, a second transistor element, a third capacitor, a fourth capacitor, a third transistor element, a fourth transistor element, a fifth capacitor, a sixth capacitor, a first conductive element, a second conductive element, a third conductive element, a fourth conductive element, a load resistor and a load capacitor. The first capacitor is connected to the first input node and a first node; the second capacitor is connected to the second input node and a second node; the first transistor element is connected between the first node and a ground terminal; the second transistor element is connected between the second node and the ground terminal; the third capacitor is connected to the first node and the second transistor element; the fourth capacitor is connected to the second node and the first transistor element; the third transistor element is connected between the first node and an output node; the fourth transistor element is connected between the second node and the output node; the fifth capacitor is connected to the first node and the fourth transistor element; and the sixth capacitor is connected to the second node and the third transistor element. The first conductive element is connected to the first transistor element and the ground terminal, and when the first conductive element is turned on, a voltage of a first gate of the first transistor element may be reduced. The second conductive element is connected to the second transistor element and the ground terminal, and when the second conductive element is turned on, a voltage of a second gate of the second transistor element may be reduced. The third conductive element is connected to the third transistor element and the output node, and when the third conductive element is turned on, a voltage of a third gate of the third transistor element may be increased. The fourth conductive element is connected to the fourth transistor element and the output node, and when the fourth conductive element is turned on, a voltage of a fourth gate of the fourth transistor element may be increased. One end of the load resistor is connected to the output node, and one end of the load capacitor is connected to the output node.

In an embodiment, when a first radio frequency signal of the first input node is greater than a second radio frequency signal of the second input node, the second transistor element and the third transistor element are in an on-state, the first transistor element and the fourth transistor element are in a cut-off state, and a radio frequency input current of the first radio frequency signal charges the load capacitor to convert the first radio frequency signal into a DC voltage. When the second radio frequency signal of the second input node is greater than the first radio frequency signal of the first input node, the first transistor element and the fourth transistor element are in an on-state, the second transistor element and the third transistor element are in a cut-off state, and a radio frequency input current of the second radio frequency signal charges the load capacitor to convert the second radio frequency signal into the DC voltage.

In an embodiment, a first source of the first transistor element is connected to the ground terminal, a first drain is connected to the first node, and the first gate is connected to the first conductive element and the fourth capacitor. When a voltage difference between the second radio frequency signal and a common-mode voltage of the ground terminal is greater than a threshold voltage of the first conductive element, the first conductive element is turned on, and the voltage of the first gate of the first transistor element is reduced to reduce a leakage current of the first transistor element.

In an embodiment, a second source of the second transistor element is connected to the ground terminal, a second drain is connected to the second node, and the second gate is connected to the second conductive element and the third capacitor. When a voltage difference between the first radio frequency signal and a common-mode voltage of the ground terminal is greater than a threshold voltage of the second conductive element, the second conductive element is turned on, and the voltage of the second gate of the second transistor element is reduced to reduce a leakage current of the second transistor element.

In an embodiment, a third source of the third transistor element is connected to the first node, a third drain is connected to the output node, and the third gate is connected to the third conductive element and the sixth capacitor. When a voltage difference between the second radio frequency signal and the DC voltage of the output node is greater than a threshold voltage of the third conductive element, the third conductive element is turned on, and the voltage of the third gate of the third transistor element is increased to reduce a leakage current of the third transistor element.

In an embodiment, a fourth source of the fourth transistor element is connected to the second node, a fourth drain is connected to the output node, and the fourth gate is connected to the fourth conductive element and the fifth capacitor. When a voltage difference between the first radio frequency signal and the DC voltage of the output node is greater than a threshold voltage of the fourth conductive element, the fourth conductive element is turned on, and the voltage of the fourth gate of the fourth transistor element is increased to reduce a leakage current of the fourth transistor element.

In an embodiment, the first transistor element and the second transistor element are respectively an N-type metal-oxide-semiconductor field-effect transistor; and the third transistor element and the fourth transistor element are respectively a P-type metal-oxide-semiconductor field-effect transistor.

In an embodiment, the first conductive element, the second conductive element, the third conductive element and the fourth conductive element are respectively a diode or a diode-connected transistor.

In an embodiment, the first conductive element and the second conductive element are respectively a P-type metal-oxide-semiconductor field-effect transistor; and the third conductive element and the fourth conductive element are respectively an N-type metal-oxide-semiconductor field-effect transistor.

The disclosure further provides a radio frequency rectifier device, which includes a first input node, a second input node, a plurality of radio frequency rectifier units, a load resistor and a load capacitor to form a multi-stage radio frequency rectifier device via the plurality of radio frequency rectifier units connected in series. In the radio frequency rectifier device, the plurality of radio frequency rectifier units are connected between the first input node and the second input node and connected in series in sequence; one end of the load resistor is connected to an output node of the radio frequency rectifier unit at a tail end; and one end of the load capacitor is also connected to the output node of the radio frequency rectifier unit at the tail end. Each radio frequency rectifier unit includes a first capacitor, a second capacitor, a first transistor element, a second transistor element, a third capacitor, a fourth capacitor, a third transistor element, a fourth transistor element, a fifth capacitor, a sixth capacitor, a first conductive element, a second conductive element, a third conductive element and a fourth conductive element.

In summary, to improve the conversion efficiency of the rectifier device at a low radio frequency input power level without increasing the on resistance of the transistor operating at a high radio frequency input signal level, the disclosure provides a radio frequency rectifier device to improve the deficiency of a reverse leakage current of a full-wave rectifier with a self-bias feedback technology of a dual-loop design in a differential cross-coupled rectifier device, thereby improving the power conversion efficiency of the rectifier device operating at the low radio frequency input power level.

### BRIEF DESCRIPTION OF THE DRAWINGS

FIG. 1 is a schematic architecture diagram of a radio frequency energy capturing system applied in the disclosure.

FIG. 2 is a schematic circuit diagram of a radio frequency rectifier device according to an embodiment of the disclosure.

FIG. 3 is a schematic diagram of a charging path of a radio frequency rectifier device at a differential radio frequency signal according to the disclosure.

FIG. 4 is a node waveform diagram of a second transistor element in a radio frequency rectifier device according to the disclosure.

FIG. 5 is a node waveform diagram of a third transistor element in a radio frequency rectifier device according to the disclosure.

FIG. 6 is a schematic circuit diagram of a radio frequency rectifier device according to another embodiment of the disclosure.

FIG. 7 is a schematic circuit diagram of a radio frequency rectifier device integrated with a plurality of radio frequency rectifier units according to an embodiment of the disclosure.

### DETAILED DESCRIPTION

Preferred embodiments are provided below for detailed explanation. However, the embodiments are only used as an example for explanation and do not limit the scope of protection of the disclosure. Furthermore, some elements are omitted in the drawings in the embodiments to clearly display the technical features of the disclosure. The same reference numerals in all figures are used for indicating the same or similar elements.

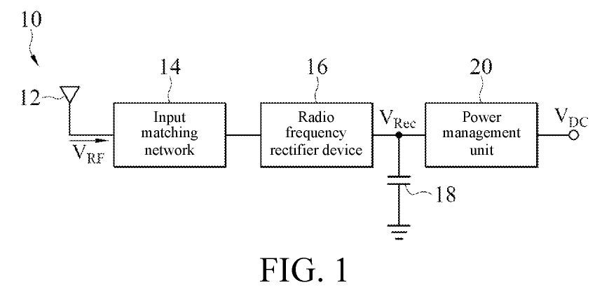

FIG. 1 is a schematic architecture diagram of a radio frequency energy capturing system applied in the disclosure. Referring to FIG. 1, a radio frequency energy capturing system 10 includes an antenna 12, an input matching network 14, a radio frequency rectifier device 16, an energy storage element 18 and a power management unit 20. The antenna 12 captures a radio frequency signal V_{RF} in the environment, and the design and selection of the antenna 12 are determined according to the frequency and power level of the radio frequency signal V_{RF} to be captured. The input matching network 14 is connected to the antenna 12 to receive the radio frequency signal V_{RF} and perform impedance matching, thereby achieving the maximum transmission power. The radio frequency rectifier device 16 is connected to the input matching network 14 to receive the matched radio frequency signal V_{RF} and convert the radio frequency signal V_{RF} into a DC voltage V_{Rec}, and the effect of the disclosure is achieved by the special design of the radio frequency rectifier device 16. The power management unit 20 is connected to the radio frequency rectifier device 16 to convert the DC voltage V_{Rec} into a voltage signal V_{DC} at a specific voltage level for use by a target device. The power management unit 20 is a boost converter or a buck converter, and corresponding circuit components are selected according to the power requirements of the target device. The energy storage element 18 is connected between the radio frequency rectifier device 16 and the power management unit 20 to store the DC voltage V_{Rec} until the radio frequency rectifier device 16 generates enough DC voltage V_{Rec}. It should be noted that "connection" as used in the disclosure may include "coupling", which may refer to that two or more elements directly make physical or electrical contact with each other, or indirectly make physical or electrical contact with each other, or may refer to that two or more elements operate or act on each other.

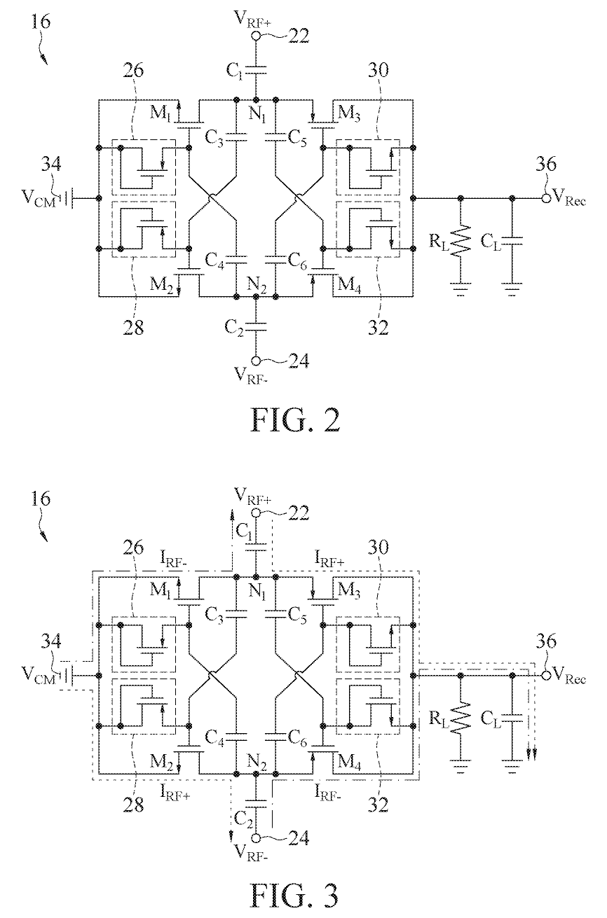

Referring to FIG. 2, a radio frequency rectifier device 16 includes a first input node 22, a first capacitor C₁, a second input node 24, a second capacitor C₂, a first transistor element M₁, a second transistor element M₂, a third capacitor C₃, a fourth capacitor C₄, a third transistor element M₃, a fourth transistor element M₄, a fifth capacitor C₅, a sixth capacitor C₆, a first conductive element 26, a second conductive element 28, a third conductive element 30, a fourth conductive element 32, a load resistor R_{L} and a load capacitor C_{L}. In the radio frequency rectifier device 16, a received differential radio frequency signal includes a first radio frequency signal V_{RF+} and a second radio frequency signal V_{RF-}, so that the first input node 22 inputs the first radio frequency signal V_{RF+} and the second input node 24 inputs the second radio frequency signal V_{RF-}. Two ends of the first capacitor C₁ are connected to the first input node 22 and a first node N₁, respectively, and two ends of the second capacitor C₂ are connected to the second input node 24 and a second node N₂, respectively. The first transistor element M₁ is connected between the first node N₁ and a ground terminal 34. The first transistor element M₁ includes a first source, a first drain and a first gate. The first source is connected to the ground terminal 34, the first drain is connected to the first node N₁, and the first gate is connected to the first conductive element 26 and the fourth capacitor C₄. The second transistor element M₂ is connected between the second node N₂ and the ground terminal 34. The second transistor element M₂ includes a second source, a second drain and a second gate. The second source is connected to the ground terminal 34, the second drain is connected to the second node N₂, and the second gate is connected to the second conductive element 28 and the third capacitor C₃. One end of the third capacitor C₃ is connected to the first node N₁, and the other end is connected to the second gate of the second transistor element M₂. One end of the fourth capacitor C₄ is connected to the second node N₂, and the other end is connected to the first gate of the first transistor element M₁. The third transistor element M₃ is connected between the first node N₁ and an output node 36. The third transistor element M₃ includes a third source, a third drain and a third gate. The third source is connected to the first node N₁, the third drain is connected to the output node 36, and the third gate is connected to the third conductive element 30 and the sixth capacitor C₆. The fourth transistor element M₄ is connected between the second node N₂ and the output node 36. The fourth transistor element M₄ includes a fourth source, a fourth drain and a fourth gate. The fourth source is connected to the second node N₂, the fourth drain is connected to the output node 36, and the fourth gate is connected to the fourth conductive element 32 and the fifth capacitor C₅. One end of the fifth capacitor C₅ is connected to the first node N₁, and the other end is connected to the fourth gate of the fourth transistor element M₄. One end of the sixth capacitor C₆ is connected to the second node N₂, and the other end is connected to the third gate of the third transistor element M₃. In an embodiment, the first transistor element M₁ and the second transistor element M₂ are each an N-type metal-oxide-semiconductor field-effect transistor (NMOS FET); and the third transistor element M₃ and the fourth transistor element M₄ are each a P-type metal-oxide-semiconductor field-effect transistor (PMOS FET).

Referring to FIG. 2 further, the first conductive element 26 is connected to the first transistor element M₁ and the ground terminal 34. In this embodiment, the first conductive element 26 is a diode-connected transistor, e.g., a P-type metal-oxide-semiconductor field-effect transistor. A source of the first conductive element 26 is connected to the first gate of the first transistor element M₁, a drain of the first conductive element 26 is connected to the ground terminal 34, and a gate of the first conductive element 26 is connected to its own drain to form self-bias feedback. When the first conductive element 26 is turned on, a voltage of the first gate of the first transistor element M₁ may be reduced to reduce a leakage current flowing through the first drain and the first source in the first transistor element M₁. The second conductive element 28 is connected to the second transistor element M₂ and the ground terminal 34. In this embodiment, the second conductive element 28 is a diode-connected transistor, e.g., a P-type metal-oxide-semiconductor field-effect transistor. A source of the second conductive element 28 is connected to the second gate of the second transistor element M₂, a drain of the second conductive element 28 is connected to the ground terminal 34, and a gate of the second conductive element 28 is connected to its own drain to form self-bias feedback. When the second conductive element 28 is turned on, a voltage of the second gate of the second transistor element M₂ may be reduced to reduce a leakage current flowing through the second drain and the second source in the second transistor element M₂. The third conductive element 30 is connected to the third transistor element M₃ and the output node 36. In this embodiment, the third conductive element 30 is a diode-connected transistor, e.g., an N-type metal-oxide-semiconductor field-effect transistor. A source of the third conductive element 30 is connected to the output node 36, a drain of the third conductive element 30 is connected to the third gate of the third transistor element M₃, and a gate of the third conductive element 30 is connected to its own drain to form self-bias feedback. When the third conductive element 30 is turned on, a voltage of the third gate of the third transistor element M₃ may be increased to reduce a leakage current flowing through the third drain and the third source in the third transistor element M₃. The fourth conductive element 32 is connected to the fourth transistor element M₄and the output node 36. In this embodiment, the fourth conductive element 32 is a diode-connected transistor, e.g., an N-type metal-oxide-semiconductor field-effect transistor. A source of the fourth conductive element 32 is connected to the output node 36, a drain of the fourth conductive element 32 is connected to the fourth gate of the fourth transistor element M₄, and a gate of the fourth conductive element 32 is connected to its own drain to form self-bias feedback. When the fourth conductive element 32 is turned on, a voltage of the fourth gate of the fourth transistor element M₄ may be increased to reduce a leakage current flowing through the fourth drain and the fourth source in the fourth transistor element M₄. One end of the load resistor R_{L} is connected to the output node 36, and the other end is connected to the ground terminal 34. One end of the load capacitor C_{L} is connected to the output node 36, and the other end is also connected to the ground terminal 34.

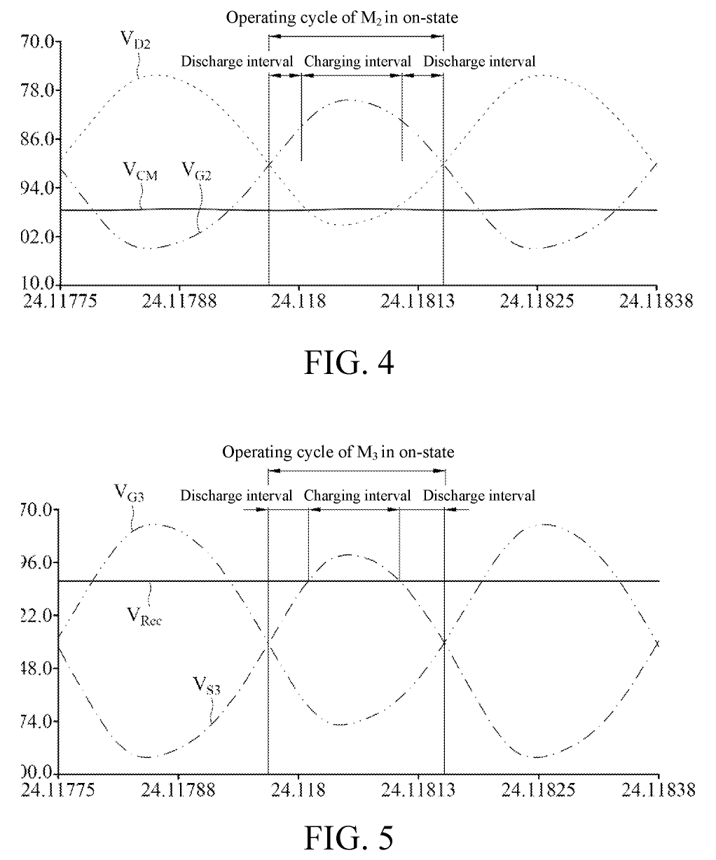

Referring to both FIG. 3 and FIG. 4, when the radio frequency rectifier device 16 receives the differential radio frequency signal, and when the first radio frequency signal V_{RF+} at the first input node 22 is greater than the second radio frequency signal V_{RF-} at the second input node 24, a second gate voltage V_{G2} of the second transistor element M₂ is greater than or equal to a second source voltage (i.e., a common-mode voltage V_{CM}), the second transistor element M₂ is in an on-state, and the first transistor element M₁ is in a cut-off state. At this time, an operating cycle of the second transistor element M₂ in the on-state is composed of a discharge interval of the load capacitor C_{L} and a charging interval of the first radio frequency signal V_{RF+}. When the second gate voltage V_{G2} is greater than or equal to a second drain voltage V_{D2} and greater than or equal to the common-mode voltage V_{CM} (also referred to as the second source voltage), that is, V_{CM} ≤ V_{D2} ≤ V_{G2}, the operating cycle of the second transistor element M₂ in the on-state is the discharge interval of the load capacitor C_{L}. When the second gate voltage V_{G2} is greater than or equal to the common-mode voltage V_{CM} (also referred to as the second source voltage) and greater than or equal to the second drain voltage V_{D2}, that is, V_{D2} ≤ V_{CM} ≤ V_{G2}, the operating cycle of the second transistor element M₂ in the on-state is the charging interval of the first radio frequency signal V_{RF+}, and a radio frequency input current I_{RF+} of the first radio frequency signal V_{RF+} charges the load capacitor C_{L} to convert the first radio frequency signal V_{RF+} into a DC voltage V_{Rec}. During the on-state of the second transistor element M₂, when a voltage difference between the first radio frequency signal V_{RF+} and the common-mode voltage V_{CM} of the ground terminal 34 is greater than a threshold voltage of the second conductive element 28, the second conductive element 28 is turned on, and the second gate voltage V_{G2} of the second transistor element M₂ is reduced, so that a leakage current of the second transistor element M₂ is reduced, thereby reducing the discharge interval, and thus improving the power conversion efficiency of the radio frequency rectifier device 16.

Referring to both FIG. 3 and FIG. 5, when the first radio frequency signal V_{RF+} at the first input node 22 is greater than the second radio frequency signal V_{RF-} at the second input node 24, a third source voltage V_{S3} of the third transistor element M₃ is greater than or equal to a third gate voltage V_{G3}, the third transistor element M₃ is in an on-state, and the fourth transistor element M₄ is in a cut-off state. At this time, an operating cycle of the third transistor element M₃ in the on-state is composed of a discharge interval of the load capacitor C_{L} and a charging interval of the first radio frequency signal V_{RF+}. When the DC voltage V_{Rec} is greater than or equal to the third source voltage V_{S3} and greater than or equal to the third gate voltage V_{G3}, that is, V_{G3} ≤ V_{S3} ≤ V_{Rec}, the operating cycle of the third transistor element M₃ in the on-state is the discharge interval of the load capacitor C_{L}. When the third source voltage V_{S3} is greater than or equal to the DC voltage V_{Rec} and greater than or equal to the third gate voltage V_{G3}, that is, V_{G3} ≤ V_{Rec} ≤ V_{S3}, the operating cycle of the third transistor element M₃ in the on-state is the charging interval of the first radio frequency signal V_{RF+}, and a radio frequency input current I_{RF+} of the first radio frequency signal V_{RF+} charges the load capacitor C_{L} to convert the first radio frequency signal V_{RF+} into the DC voltage V_{Rec}. During the on-state of the third transistor element M₃, when a voltage difference between the second radio frequency signal V_{RF-} and the DC voltage V_{Rec} of the output node 36 is greater than a threshold voltage of the third conductive element 30, the third conductive element 30 is turned on, and the third gate voltage V_{G3} of the third transistor element M₃ is increased, so that a leakage current of the third transistor element M₃ is reduced, thereby reducing the discharge interval, and thus improving the power conversion efficiency of the radio frequency rectifier device 16.

Similarly, as shown in FIG. 3, when the second radio frequency signal V_{RF-} of the second input node 24 is greater than the first radio frequency signal V_{RF+} of the first input node 22, the first transistor element M₁ and the fourth transistor element M₄ are in an on-state, the second transistor element M₂ and the third transistor element M₃ are in a cut-off state, and a radio frequency input current I_{RF-} of the second radio frequency signal V_{RF-} charges the load capacitor C_{L} to convert the second radio frequency signal V_{RF-} into the DC voltage V_{Rec}. Then, when a voltage difference between the second radio frequency signal V_{RF-} and the common-mode voltage V_{CM} of the ground terminal 34 is greater than a threshold voltage of the first conductive element 26, the first conductive element 26 is turned on, and the voltage of the first gate of the first transistor element M₁ is reduced, so that a leakage current of the first transistor element M₁ is reduced, thereby reducing a discharge interval of the first transistor element M₁, and thus improving the power conversion efficiency of the radio frequency rectifier device 16. When a voltage difference between the first radio frequency signal V_{RF+} and the DC voltage V_{Rec} of the output node 36 is greater than a threshold voltage of the fourth conductive element 32, the fourth conductive element 32 is turned on, and the voltage of the fourth gate of the fourth transistor element M₄ is increased, so that a leakage current of the fourth transistor element M₄ is reduced, thereby reducing a discharge interval of the fourth transistor element M₄, and thus improving the power conversion efficiency of the radio frequency rectifier device 16.

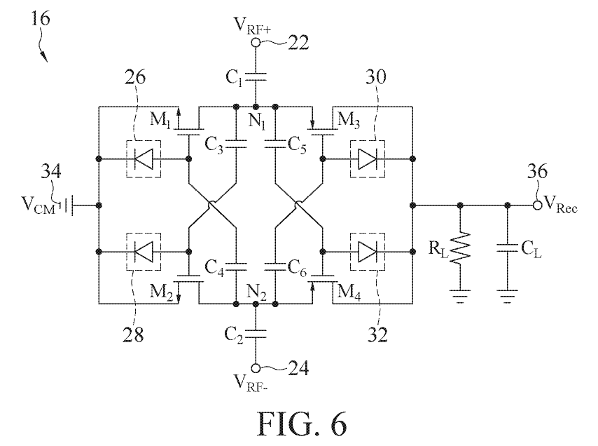

In another embodiment, referring to both FIG. 2 and FIG. 6, in the radio frequency rectifier device 16, in addition to using the diode-connected transistor as the first conductive element 26, the second conductive element 28, the third conductive element 30 and the fourth conductive element 32, the first conductive element 26, the second conductive element 28, the third conductive element 30 and the fourth conductive element 32 each may also be a diode. As shown in FIG. 6, the voltage of the first gate of the first transistor element M₁ is reduced by turning on the first conductive element 26, the voltage of the second gate of the second transistor element M₂ is reduced by turning on the second conductive element 28, the voltage of the third gate of the third transistor element M₃ is increased by turning on the third conductive element 30, and the voltage of the fourth gate of the fourth transistor element M₄ is increased by turning on the fourth conductive element 32, and thus, the leakage current of each of the first transistor element M₁, the second transistor element M₂, the third transistor element M₃ and the fourth transistor element M₄ is reduced, thereby reducing a reverse leakage current.

In an embodiment, the entire architecture of the radio frequency rectifier device 16 in the disclosure, in addition to being manufactured in a complementary metal-oxide semiconductor (CMOS) process, is not limited to being manufactured in processes having ultra low threshold voltage (ULVT), low threshold voltage (LVT), standard threshold voltage (SVT), high threshold voltage (HVT) and extra high threshold voltage (EHVT) element characteristics.

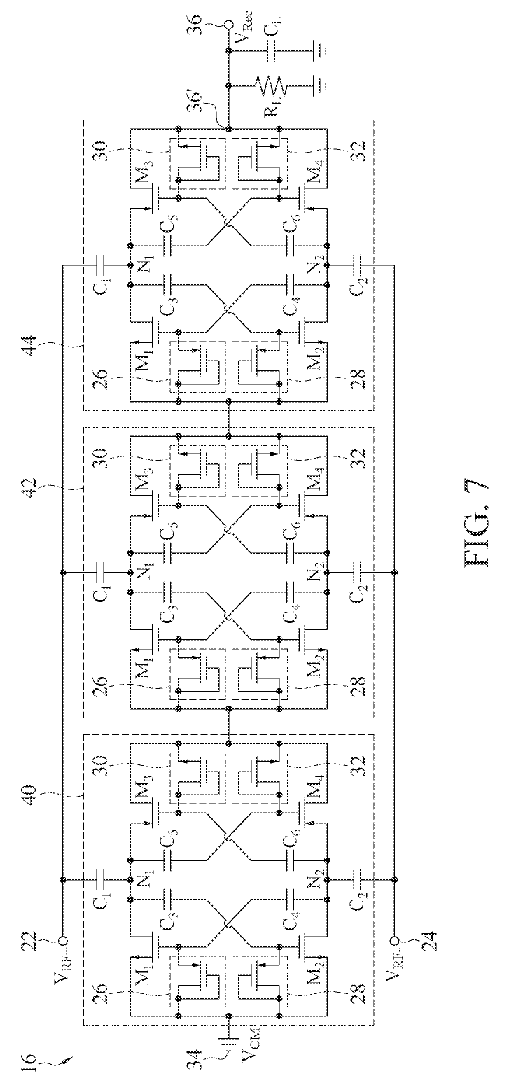

Referring to FIG. 7, a radio frequency rectifier device 16 includes a first input node 22, a second input node 24, a plurality of radio frequency rectifier units 40, 42 and 44, a load resistor R_{L}, and a load capacitor C_{L}, to form a multi-stage radio frequency rectifier device via the plurality of radio frequency rectifier units 40, 42 and 44 connected in series. In the radio frequency rectifier device 16, the plurality of radio frequency rectifier units 40, 42 and 44 are respectively connected between the first input node 22 and the second input node 24. Here, three radio frequency rectifier units 40, 42 and 44 are taken as an example, but the disclosure is not limited to this number. These radio frequency rectifier units 40, 42 and 44 are connected in series in sequence, one end of the load resistor R_{L} is connected to an output node 36' of the radio frequency rectifier unit 44 at a tail end, and one end of the load capacitor C_{L} is also connected to the output node 36' of the radio frequency rectifier unit 44 at the tail end, thereby forming a multi-stage radio frequency rectifier device. Each of the radio frequency rectifier units 40, 42 and 44 includes a first capacitor C₁, a second capacitor C₂, a first transistor element M₁, a second transistor element M₂, a third capacitor C₃, a fourth capacitor C₄, a third transistor element M₃, a fourth transistor element M₄, a fifth capacitor C₅, a sixth capacitor C₆, a first conductive element 26, a second conductive element 28, a third conductive element 30 and a fourth conductive element 32. The detailed connection relationships and operations of each of the radio frequency rectifier units 40, 42 and 44 are the same as those in the embodiments shown in FIG. 2 and FIG. 3, so reference can be made to the above description, which will not be repeated here.

In summary, to improve the conversion efficiency of the rectifier device at a low radio frequency input power level without increasing the on resistance of the transistor operating at a high radio frequency input signal level, the disclosure provides a radio frequency rectifier device to improve the deficiency of a reverse leakage current of a full-wave rectifier with a self-bias feedback technology of a dual-loop design in a differential cross-coupled rectifier device, thereby improving the power conversion efficiency of the rectifier device operating at the low radio frequency input power level.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A radio frequency rectifier device, comprising:
a first input node;
a first capacitor, connected to the first input node and a first node;
a second input node;
a second capacitor, connected to the second input node and a second node;
a first transistor element, connected between the first node and a ground terminal;
a second transistor element, connected between the second node and the ground terminal;
a third capacitor, connected to the first node and the second transistor element;
a fourth capacitor, connected to the second node and the first transistor element;
a third transistor element, connected between the first node and an output node;
a fourth transistor element, connected between the second node and the output node;
a fifth capacitor, connected to the first node and the fourth transistor element;
a sixth capacitor, connected to the second node and the third transistor element;
a first conductive element, connected to the first transistor element and the ground terminal, wherein when the first conductive element is turned on, a voltage of a first gate of the first transistor element is reduced;
a second conductive element, connected to the second transistor element and the ground terminal, wherein when the second conductive element is turned on, a voltage of a second gate of the second transistor element is reduced;
a third conductive element, connected to the third transistor element and the output node, wherein when the third conductive element is turned on, a voltage of a third gate of the third transistor element is increased;
a fourth conductive element, connected to the fourth transistor element and the output node, wherein when the fourth conductive element is turned on, a voltage of a fourth gate of the fourth transistor element is increased;
a load resistor, one end of the load resistor is connected to the output node; and
a load capacitor, one end of the load capacitor is connected to the output node.

2. The radio frequency rectifier device according to claim 1, wherein when a first radio frequency signal of the first input node is greater than a second radio frequency signal of the second input node, the second transistor element and the third transistor element are in an on-state, the first transistor element and the fourth transistor element are in a cut-off state, and a radio frequency input current of the first radio frequency signal charges the load capacitor to convert the first radio frequency signal into a DC voltage; and when the second radio frequency signal of the second input node is greater than the first radio frequency signal of the first input node, the first transistor element and the fourth transistor element are in an on-state, the second transistor element and the third transistor element are in a cut-off state, and a radio frequency input current of the second radio frequency signal charges the load capacitor to convert the second radio frequency signal into the DC voltage.

3. The radio frequency rectifier device according to claim 2, wherein a first source of the first transistor element is connected to the ground terminal, a first drain is connected to the first node, the first gate is connected to the first conductive element and the fourth capacitor, and when a voltage difference between the second radio frequency signal and a common-mode voltage of the ground terminal is greater than a threshold voltage of the first conductive element, the first conductive element is turned on, and the voltage of the first gate of the first transistor element is reduced to reduce a leakage current of the first transistor element.

4. The radio frequency rectifier device according to claim 2, wherein a second source of the second transistor element is connected to the ground terminal, a second drain is connected to the second node, the second gate is connected to the second conductive element and the third capacitor, and when a voltage difference between the first radio frequency signal and a common-mode voltage of the ground terminal is greater than a threshold voltage of the second conductive element, the second conductive element is turned on, and the voltage of the second gate of the second transistor element is reduced to reduce a leakage current of the second transistor element.

5. The radio frequency rectifier device according to claim 2, wherein a third source of the third transistor element is connected to the first node, a third drain is connected to the output node, the third gate is connected to the third conductive element and the sixth capacitor, and when a voltage difference between the second radio frequency signal and the DC voltage of the output node is greater than a threshold voltage of the third conductive element, the third conductive element is turned on, and the voltage of the third gate of the third transistor element is increased to reduce a leakage current of the third transistor element.

6. The radio frequency rectifier device according to claim 2, wherein a fourth source of the fourth transistor element is connected to the second node, a fourth drain is connected to the output node, the fourth gate is connected to the fourth conductive element and the fifth capacitor, and when a voltage difference between the first radio frequency signal and the DC voltage of the output node is greater than a threshold voltage of the fourth conductive element, the fourth conductive element is turned on, and the voltage of the fourth gate of the fourth transistor element is increased to reduce a leakage current of the fourth transistor element.

7. The radio frequency rectifier device according to claim 1, wherein the first transistor element and the second transistor element are respectively an N-type metal-oxide-semiconductor field-effect transistor; and the third transistor element and the fourth transistor element are respectively a P-type metal-oxide-semiconductor field-effect transistor.

8. The radio frequency rectifier device according to claim 1, wherein the first conductive element, the second conductive element, the third conductive element and the fourth conductive element are respectively a diode.

9. The radio frequency rectifier device according to claim 1, wherein the first conductive element, the second conductive element, the third conductive element and the fourth conductive element are respectively a diode-connected transistor.

10. The radio frequency rectifier device according to claim 9, wherein the first conductive element and the second conductive element are respectively a P-type metal-oxide-semiconductor field-effect transistor; and the third conductive element and the fourth conductive element are respectively an N-type metal-oxide-semiconductor field-effect transistor.

11. A radio frequency rectifier device, comprising:
a first input node;
a second input node;
a plurality of radio frequency rectifier units, connected between the first input node and the second input node and connected in series in sequence, wherein each radio frequency rectifier unit comprises:
a first capacitor, connected to the first input node and a first node;
a second capacitor, connected to the second input node and a second node;
a first transistor element, connected between the first node and a ground terminal;
a second transistor element, connected between the second node and the ground terminal;
a third capacitor, connected to the first node and the second transistor element;
a fourth capacitor, connected to the second node and the first transistor element;
a third transistor element, connected between the first node and an output node;
a fourth transistor element, connected between the second node and the output node;
a fifth capacitor, connected to the first node and the fourth transistor element;
a sixth capacitor, connected to the second node and the third transistor element;
a first conductive element, connected to the first transistor element and the ground terminal, wherein when the first conductive element is turned on, a voltage of a first gate of the first transistor element is reduced;
a second conductive element, connected to the second transistor element and the ground terminal, wherein when the second conductive element is turned on, a voltage of a second gate of the second transistor element is reduced;
a third conductive element, connected to the third transistor element and the output node, wherein when the third conductive element is turned on, a voltage of a third gate of the third transistor element is increased; and
a fourth conductive element, connected to the fourth transistor element and the output node, wherein when the fourth conductive element is turned on, a voltage of a fourth gate of the fourth transistor element is increased;
a load resistor, one end of the load resistor is connected to the output node of the radio frequency rectifier unit at a tail end; and
a load capacitor, one end of the load capacitor is connected to the output node of the radio frequency rectifier unit at the tail end.

12. The radio frequency rectifier device according to claim 11, wherein when a first radio frequency signal of the first input node is greater than a second radio frequency signal of the second input node, the second transistor element and the third transistor element are in an on-state, the first transistor element and the fourth transistor element are in a cut-off state, and a radio frequency input current of the first radio frequency signal charges the load capacitor to convert the first radio frequency signal into a DC voltage; and when the second radio frequency signal of the second input node is greater than the first radio frequency signal of the first input node, the first transistor element and the fourth transistor element are in an on-state, the second transistor element and the third transistor element are in a cut-off state, and a radio frequency input current of the second radio frequency signal charges the load capacitor to convert the second radio frequency signal into the DC voltage.

13. The radio frequency rectifier device according to claim 12, wherein a first source of the first transistor element is connected to the ground terminal, a first drain is connected to the first node, the first gate is connected to the first conductive element and the fourth capacitor, and when a voltage difference between the second radio frequency signal and a common-mode voltage of the ground terminal is greater than a threshold voltage of the first conductive element, the first conductive element is turned on, and the voltage of the first gate of the first transistor element is reduced to reduce a leakage current of the first transistor element.

14. The radio frequency rectifier device according to claim 12, wherein a second source of the second transistor element is connected to the ground terminal, a second drain is connected to the second node, the second gate is connected to the second conductive element and the third capacitor, and when a voltage difference between the first radio frequency signal and a common-mode voltage of the ground terminal is greater than a threshold voltage of the second conductive element, the second conductive element is turned on, and the voltage of the second gate of the second transistor element is reduced to reduce a leakage current of the second transistor element.

15. The radio frequency rectifier device according to claim 12, wherein a third source of the third transistor element is connected to the first node, a third drain is connected to the output node, the third gate is connected to the third conductive element and the sixth capacitor, and when a voltage difference between the second radio frequency signal and the DC voltage of the output node is greater than a threshold voltage of the third conductive element, the third conductive element is turned on, and the voltage of the third gate of the third transistor element is increased to reduce a leakage current of the third transistor element.

16. The radio frequency rectifier device according to claim 12, wherein a fourth source of the fourth transistor element is connected to the second node, a fourth drain is connected to the output node, the fourth gate is connected to the fourth conductive element and the fifth capacitor, and when a voltage difference between the first radio frequency signal and the DC voltage of the output node is greater than a threshold voltage of the fourth conductive element, the fourth conductive element is turned on, and the voltage of the fourth gate of the fourth transistor element is increased to reduce a leakage current of the fourth transistor element.

17. The radio frequency rectifier device according to claim 11, wherein the first transistor element and the second transistor element are respectively an N-type metal-oxide-semiconductor field-effect transistor; and the third transistor element and the fourth transistor element are respectively a P-type metal-oxide-semiconductor field-effect transistor.

18. The radio frequency rectifier device according to claim 11, wherein the first conductive element, the second conductive element, the third conductive element and the fourth conductive element are respectively a diode.

19. The radio frequency rectifier device according to claim 11, wherein the first conductive element, the second conductive element, the third conductive element and the fourth conductive element are respectively a diode-connected transistor.

20. The radio frequency rectifier device according to claim 19, wherein the first conductive element and the second conductive element are respectively a P-type metal-oxide-semiconductor field-effect transistor; and the third conductive element and the fourth conductive element are respectively an N-type metal-oxide-semiconductor field-effect transistor.
